(19) United States
(12) Patent Application Publication
(10) Pub. No.: US 2006/0032139 A1
(43) Pub. Date: Feb. 16, 2006

(54) Method for gasifying biomass and catalyst used for said method

(75) Inventors: Muneyoshi Yamada, Sendai-shi (JP); Keiichi Tomishige, Toride-shi (JP); Mohammad Asadullah, Matsudo-shi (JP); Kimio Kunimori, Tsukuba-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: President of Tohoku University, Aoba-ku (JP)

(21) Appl. No.: 11/243,163

(22) Filed: Oct. 5, 2005

Related U.S. Application Data
(63) Continuation of application No. 10/315,203, filed on Dec. 10, 2002, now abandoned.

(30) Foreign Application Priority Data
Dec. 18, 2001 (JP) 2001-384857

(51) Int. Cl. C01B 3/32

(52) U.S. Cl. 48/198.6

(57) ABSTRACT

Disclosed is a method of gasifying a biomass, comprising heating a fluidized bed reactor loaded with a catalyst represented by Rh/CeO₂/M, where M represents SiO₂, Al₂O₃ or ZrO₂, to temperatures lower than 800° C. introducing biomass particles into the fluidized bed reactor from an upper portion thereof, introducing air and steam into the fluidized bed reactor from a lower portion thereof, and allowing the biomass particles to react at the surface of the Rh/CeO₂/M catalyst so as to manufacture hydrogen and a syngas.

### CROSS-REFERENCE TO RELATED APPLICATIONS

This application is based upon and claims the benefit of priority from the prior Japanese Patent Application No. 2001-384857, filed Dec. 18, 2001, the entire contents of which are incorporated herein by reference.

### BACKGROUND OF THE INVENTION

1. Field of the Invention

The present invention relates to a method of gasifying a biomass and a catalyst used for the gasifying method.

2. Description of the Related Art

In general, the manufacture of a syngas by Utilizing gasification of a biomass such as cellulose is carried at a high temperature of at least 800° C. If the syngas is manufactured at temperatures lower than 800° C., the biomass is partly converted into tar or char, resulting in failure to carry out a stable operation. The formation of tar or char tends to increase with decrease in the reaction temperature, with the result that it is considered difficult to gasify the biomass under low temperatures.

In order to gasify the biomass at low temperatures without giving rise to any inconvenience, it is indispensable to use an appropriate catalyst. However, such a catalyst has not yet been developed.

### BRIEF SUMMARY OF THE INVENTION

An object of the present invention is to provide a method of manufacturing hydrogen and a syngas by efficiently gasifying a biomass at low temperatures, i.e., temperatures lower than 800° C., without forming tar or char on the surface of the catalyst.

Another object of the present invention is to provide a catalyst effective for efficiently gasifying a biomass without forming tar or char on the surface of the catalyst even at temperatures lower than 800° C. so as to manufacture hydrogen and a syngas.

According to an aspect of the present invention, there is provided a method of gasifying a biomass, comprising:
heating a fluidized bed reactor loaded with a catalyst represented by Rh/CeO₂/M, where M represents SiO₂, Al₂O₃ or ZrO₂, to temperatures lower than 800° C.;
introducing biomass particles into the fluidized bed reactor from an upper portion thereof;
introducing air and steam into the fluidized bed reactor from a lower portion thereof; and
allowing the biomass particles to react at the surface of the Rh/CeO₂/M catalyst so as to manufacture hydrogen and a syngas.

According to another aspect of the present invention, there is provided a catalyst for gasification of a biomass, the catalyst being represented by Rh/CeO₂/M, where M represents SiO₂, Al₂O₃ or ZrO₂.

Additional objects and advantages of the present invention will be set forth in the description which follows, and in part will be obvious from the description, or may be learned by practice of the present invention. The objects and advantages of the present invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the present invention, and together with the general description given above and the detailed description of the preferred embodiments given below, serve to explain the principles of the present invention.

FIG. 1 schematically shows the construction of a continuous supply fluidized bed reactor used in the Example of the present invention;

FIG. 2 is a graph showing the changes with time in the carbon conversion rate (C-conv) and in the distribution of formed products in the gasification of cellulose carried out in the presence of a catalyst represented by Rh/CeO₂/SiO₂(35);

FIG. 3 is a graph showing the changes with time in the C-conv. and in the distribution of formed products in the gasification of cellulose carried out in the presence of an Rh/SiO₂ catalyst;

FIG. 4 is a graph showing the changes with time in the C-conv. and in the distribution of formed products in the gasification of cellulose carried out in the presence of a G-91 catalyst;

FIG. 5 is a graph showing the changes with time in the C-conv. and in the distribution of formed products in the gasification of cellulose carried out in the presence of a Rh/CeO₂ catalyst;

FIG. 6 is a graph showing the changes with time in the C-conv. and in the distribution of formed products in the gasification of cellulose carried out in the presence of a catalyst represented by Rh/CeO₂/Al₂O₃ (30);

FIG. 7 is a graph showing the changes with time in the C-conv. and in the distribution of formed products in the gasification of cellulose carried out in the presence of a catalyst represented by Rh/CeO₂/ZrO₂(50);

FIG. 8 is a graph showing the changes with temperature in the C-conv. and in the distribution of formed products in the gasification of cellulose carried out in the presence of a catalyst represented by Rh/CeO₂/SiO₂(35);

FIG. 9 is a graph showing the changes with temperature in the C-conv. and in the distribution of formed products in the gasification of cellulose carried out in the presence of a Rh/SiO₂ catalyst;

FIG. 10 is a graph showing the changes with temperature in the C-conv. and in the distribution of formed products in the gasification of cellulose carried out in the presence of a G-91 catalyst;

FIG. 11 is a graph showing the changes with temperature in the C-conv. and in the distribution of formed products in the gasification of cellulose carried out in the presence of a Rh/CeO₂ catalyst;

FIG. 12 is a graph showing the changes with temperature in the C-conv. and in the distribution of formed products in the gasification of cellulose carried out in the presence of a Rh/CeO₂/Al₂O₃ catalyst;

FIG. 13 is a graph showing the changes with temperature in the C-conv. and in the distribution of formed products in the gasification of cellulose carried out in the presence of an Rh/CeO₂/ZrO₂ catalyst;

FIG. 14 is a graph showing how the C-conv., tar formation and char formation are affected by the CeO₂ content of the Rh/CeO₂/SiO₂ catalyst;

FIG. 15 is a graph showing the influences given by steam in the gasification of cellulose carried out in the presence of a catalyst represented by Rh/CeO₂/SiO₂ (35);

FIG. 16 is a graph showing the influences given by steam in the gasification of cellulose carried out in the presence of a catalyst represented by Rh/CeO₂/SiO₂ (35);

FIG. 17 is a graph showing the influences given by temperature in the gasification of cellulose carried out in the presence of a catalyst represented by Rh/CeO₂/SiO₂(35);

FIGS. 18A and 18B are graphs each showing the influences given by air flow rate in the gasification of cellulose carried out in the presence of a catalyst represented by Rh/CeO₂/SiO₂(35);

FIG. 19 is a graph showing the relationship between the hydrogen yield and the carbon yield in the gasification of cellulose carried out in the presence of a catalyst represented by Rh/CeO₂/SiO₂(35);

FIG. 20 schematically shows the model of the reaction carried out in the fluidized bed reactor according to one embodiment of the present invention;

FIG. 21 is a graph showing the changes with time in the C-conv. and the distribution of the formed products in the gasification of a cedar powder carried out in the presence of a catalyst represented by Rh/CeO₂/SiO₂(60);

FIG. 22 is a graph showing the changes with temperature in the C-conv. and the distribution of the formed products in the gasification of a cedar powder carried out in the presence of a catalyst represented by Rh/CeO₂/SiO₂(60); and

FIG. 23 is a graph showing the changes with temperature in the forming rate of CO+H₂+CH₄ in the gasification of a cedar powder carried out in the presence of a catalyst represented by Rh/CeO₂/SiO₂(60).

### DETAILED DESCRIPTION OF THE INVENTION

The present invention will now be described in more detail with reference to specific examples.

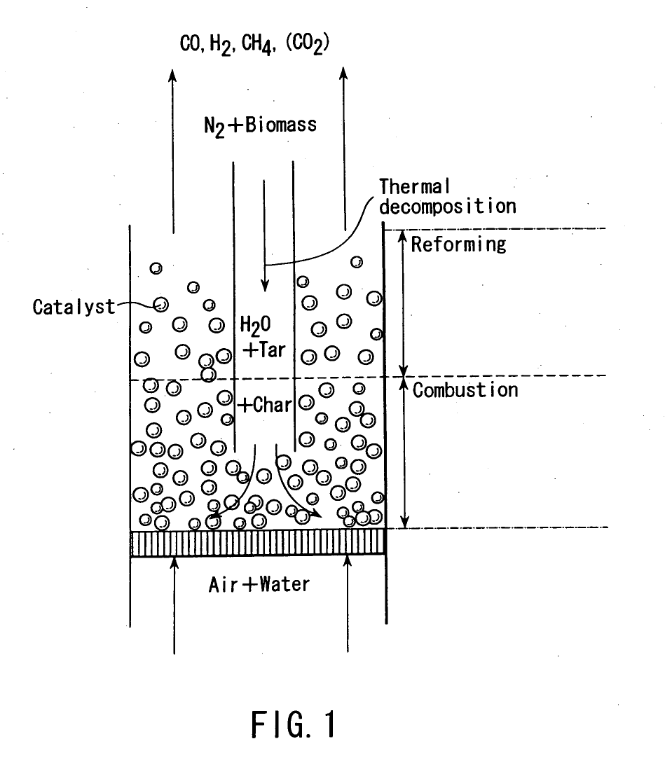

Specifically, cellulose particles manufactured by Merck Inc. and having a particle diameter of 100 to 160 μm were gasified by using the apparatus schematically shown in FIG. 1.

A container made of glass was used as a feeder, and a glass cock for controlling the supply was formed in a bottom portion of the feeder. Cellulose particles were supplied into a catalyst bed by using an N₂ gas stream passing through an inner tube having inner diameters of 5 mm and 8 mm. The gasification reactor was formed of a quartz tube having a height of 66 cm and an inner diameter of 1.8 cm and included a fluidized bed portion. Air and water were introduced into the gasification reactor from the bottom portion so as to reach the catalyst bed through a quartz dispersion plate. Steam was supplied by using a micro feeder. Water that was evaporated during its upward movement through a capillary tube made of stainless steel was introduced into the reactor through the bottom of the dispersion plate.

The temperature of the catalyst layer was measured at various points by using thermocouples. The process was carried out under atmospheric pressure by adding 3 g of a catalyst to the fluidized bed. In the initial test, the catalyst was pretreated under an H₂ stream of 40 cm³/min at 773K for 30 minutes. The temperature gradient between the outer portion and the inner portion of the reactor was also measured. A thermocouple mounted on the outer wall of the reactor was connected to a temperature controller so as to control the thermocouple as a reaction temperature. The concentrations of CO, CO₂, CH₄ and hydrocarbons were measured by an FID-GC equipped with a methanator using a stainless steel column loaded with Gasukuropack 54. Also, the concentration of hydrogen was measured by a TCD-GC using a stainless steel column loaded with a molecular sieve 13×. The flow rate of the gas flowing out of the reactor was measured by a soap membrane meter. The forming rate of the gas formed was calculated from the GC analysis of the gas flowing out of the reactor in the unit of μmol/min. The carbon conversion rate (C-conv) was calculated by “A/B×100”, where A represents the forming rate of CO+C₂+CH₄, and B represents the total C supply rate of cellulose. The C-conv. and forming rate are average values over 25 minutes. The amount of char was determined by the amount of the gas (mainly CO₂) formed under the air stream at the reaction temperature after the supply of cellulose was stopped.

The catalyst used will now be described.

First of all, CeO₂/M type carriers of various compositions were prepared by an incipient wetness method using an aqueous solution of Ce(NH₄)₂(NO₃)₆ and M selected from the group consisting of SiO₂ (Aerosil 380, 200 and 50 m²/g), Al₂O₃ (Aerosil aluminum oxide C 100 m²/g) and ZrO₂ (Dai-ichi Kigenso Kagaku Kogyo, 100 m²/g).

CeO₂ (70 m²/g) was also obtained from Dai-ichi Kigenso Kagaku Kogyo. The support was dried at 393 K for 12 hours, and then heat-treated at 773 K for 3 hours in air. Rh was supported by the support by impregnating the support with an acetone solution of Rh(C₅H₇O₂)₃. The size of the catalyst particle fell within a range of between 74 μm and 250 μm. In each test, a pretreatment was carried out by using 3 g of the catalyst at 773K for 30 minutes under a hydrogen stream of 40 cm³/min. The BET surface areas before use (immediately after H₂ treatment) and after use were measured by using a Gemini manufactured by Micrometrics Inc.

Incidentally, the catalysts available on the market (TOYO, CCI, G-91) contained 14% by weight of Ni, 65 to 70% by weight of Al₂O₃, 10 to 14% by weight of CaO and 1.4 to 1.8% by weight of K₂O.

Activation tests of the catalysts were carried out at 773K for 25 minutes. Table 1 below shows the evaluations of the catalysts.

TABLE 1

| | | | | | | | | | Surface area | |
|---|---|---|---|---|---|---|---|---|---|---|
| | Formation rate/μmol/min | | | | | C-conv. | Char | Tar | m²/g | |
| Catalyst | CO | H₂ | CH₄ | CO₂ | H₂/CO | (%)^{a} | (%)^{b} | (%)^{c} | Fresh | Used |
| None-catalyst | 152 | 24 | 5 | 569 | 0.2 | 23 | | | | |
| Rh/CeO₂ | 1158 | 1764 | 35 | 898 | 1.5 | 67 | 11 | 22 | 59 | 13 |
| G-91 | 477 | 964 | 284 | 1202 | 2.0 | 62 | 18 | 20 | — | — |
| Rh/SiO₂ | 970 | 838 | 128 | 632 | 0.9 | 55 | 9 | 36 | 312 | 310 |
| Rh/CeO₂/SiO₂ (10) | 546 | 777 | 377 | 1255 | 1.4 | 69 | 11 | 20 | 285 | 277 |
| Rh/CeO₂/SiO₂ (20) | 516 | 742 | 648 | 1253 | 1.4 | 77 | 7 | 16 | 250 | 247 |
| Rh/CeO₂/SiO₂ (35) | 845 | 1077 | 676 | 1178 | 1.3 | 86 | 6 | 8 | 208 | 206 |
| Rh/CeO₂/SiO₂ (50) | 927 | 1200 | 750 | 999 | 1.3 | 85 | 6 | 9 | 183 | 176 |
| Rh/CeO₂/SiO₂ (80) | 975 | 1370 | 625 | 912 | 1.4 | 79 | 5 | 16 | 82 | 77 |
| Rh/CeO₂/SiO₂ (30)^{e} | 1189 | 1684 | 141 | 1049 | 1.3 | 76 | 15 | 9 | 180 | 177 |
| Rh/CeO₂/SiO₂ (10)^{f} | 1321 | 1295 | 170 | 710 | 1.0 | 70 | 13 | 17 | 62 | 58 |
| Rh/CeO₂/ZrO₂ (10) | 842 | 816 | 506 | 949 | 1.0 | 73 | 16 | 11 | 87 | 86 |
| Rh/CeO₂/ZrO₂ (50) | 886 | 1212 | 548 | 897 | 1.4 | 74 | 14 | 12 | 74 | 76 |
| Rh/CeO₂/Al₂O₃ (20) | 399 | 613 | 574 | 1177 | 1.2 | 68 | 17 | 15 | 66 | 61 |
| Rh/CeO₂/Al₂O₃ (30) | 448 | 836 | 585 | 1364 | 1.8 | 76 | 14 | 10 | 63 | 56 |

In Table 1, the values within the parentheses for the catalysts represent the CeO₂ contents in terms of % by weight.

The conditions of the reaction were as follows:
Cellulose supply rate: 85 mg/min (C: 3148 μmol/min, H: 5245 μmol/min, O: 2623 μmol/min);
Air flow rate: 51 cm³/min (O₂: 417 μmol/min);
N₂ flow rate: 51 cm³/min;

The forming rate and C-conv. were average values over 25 minutes.
a: C-conv ═(CO+CO₂+CH₄ forming rate)/(C supply amount of cellulose)×100;
b: char (%)=(CO₂ forming rate after reaction)/(total C amount of supplied cellulose)×100;
c: tar (%)=(100−(C-conv %)−(char %));
d: Rh/CeO₂ catalyst: 6 g;
e: SiO₂, 200 m²/g;
f: SiO₂, 50 m²/g.

The activating test was also performed at 827K under the same conditions as above. Table 2 shows the evaluations of the catalysts for this activating test.

TABLE 2

| | | | | | | | | | Surface area | |
|---|---|---|---|---|---|---|---|---|---|---|
| | Formation rate/μmol/min | | | | | C-conv | Char | Tar | m²/g | |
| Catalyst | CO | H₂ | CH₄ | CO₂ | H₂/CO | (%)^{a} | (%)^{b} | (%)^{c} | Fresh | Used |
| Rh/CeO₂/SiO₂ (10) | 1633 | 1705 | 233 | 840 | 1.1 | 86 | 8 | 6 | 285 | 277 |
| Rh/CeO₂/SiO₂ (35) | 1250 | 1286 | 653 | 1050 | 1.1 | 94 | 4 | 2 | 208 | 206 |
| Rh/CeO₂/SiO₂ (80) | 1112 | 1126 | 542 | 954 | 1.0 | 83 | 5 | 12 | 82 | 77 |
| Rh/CeO₂/Al₂O₃ (20) | 928 | 1101 | 677 | 1084 | 1.2 | 85 | 9 | 6 | 66 | 61 |
| Rh/CeO₂/ZrO₂ (21) | 1035 | 1219 | 609 | 1103 | 1.2 | 87 | 10 | 3 | 74 | 76 |
| Rh/CeO₂ | 1522 | 2171 | 63 | 1124 | 1.5 | 86 | 9 | 5 | 59 | 13 |
| Rh/SiO₂ | 1194 | 1287 | 222 | 820 | 1.1 | 71 | 12 | 17 | 312 | 310 |
| G-91 | 798 | 1539 | 418 | 1261 | 2.0 | 79 | 18 | 3 | — | — |
| None-catalyst | 240 | 76 | 15 | 562 | 0.3 | 26 | 14 | 60 | — | — |

As apparent from Tables 1 and 2, the catalyst of Rh/CeO₂/SiO₂ (35), which exhibited the highest C-conv. and was quite free from the reduction in the BET surface area, was found to exhibit the highest performance. To be more specific, hydrogen and a syngas were generated from cellulose, air and steam, and the char was burned to form carbon dioxide and, thus, was not deposited at all on the surface of the catalyst.

On the other hand, where the catalyst was not added, the levels of the C-conv. and hydrogen manufacture were very low, and the main formed products were char and tar. This was because the reaction temperature was lower than that for the ordinary gasifying process. In this case, a sufficient contact and an excellent mixture of the thermally decomposed product and the catalyst are considered to be very important because the fluidized bed reactor was applied to the reaction system. The steam reforming catalyst (G-91) available on the market certainly permitted an increased C-conv. However, a large amount of tar was formed on the catalyst G-91. Table 2 shows that the Rh/CeO₂ catalyst permitted a considerably high C-conv. However, the BET surface area after the reaction was markedly decreased.

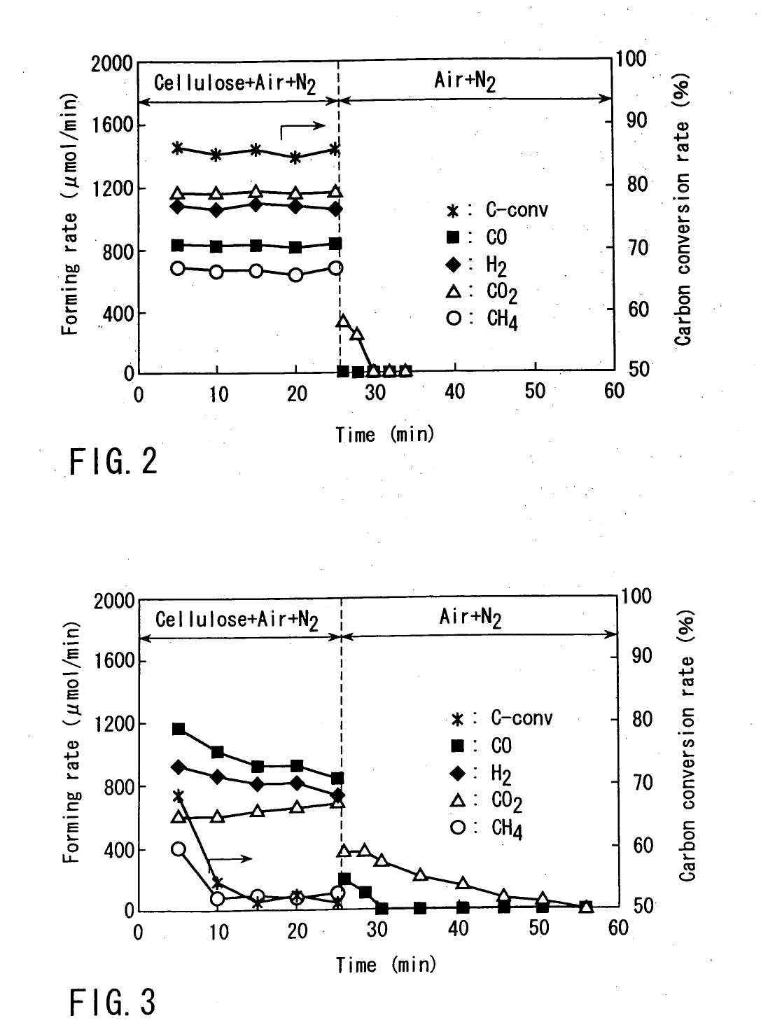

FIGS. 2 to 7 show the changes with time in the forming rate of the formed gas and in the carbon conversion rate (C-conv). In these experiments, the reaction temperature was set at 773K, and 3 g of the catalyst was used. The other conditions were as follows:
Cellulose supply rate: 85 mg/min (C: 3148 μmol/min, H: 5245 μmol/min, O: 2622 μmol/min);
Air flow rate: 51 cm³/min (O₂: 417 μmol/min);
N₂ flow rate: 51 cm³/min.

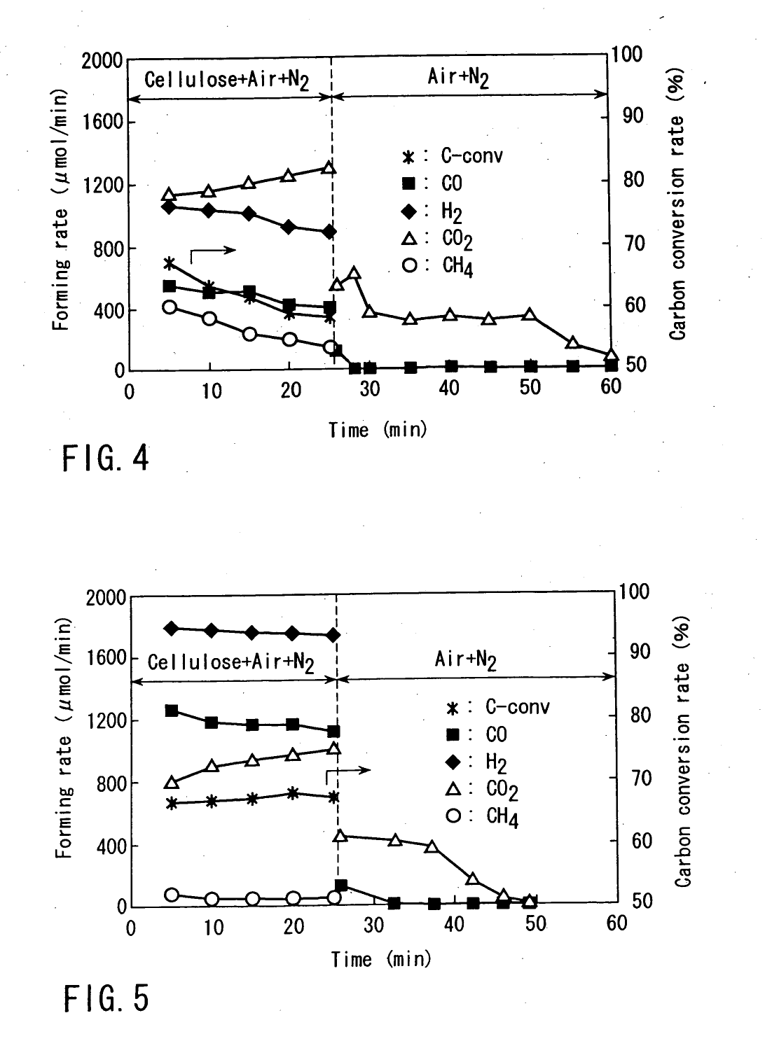

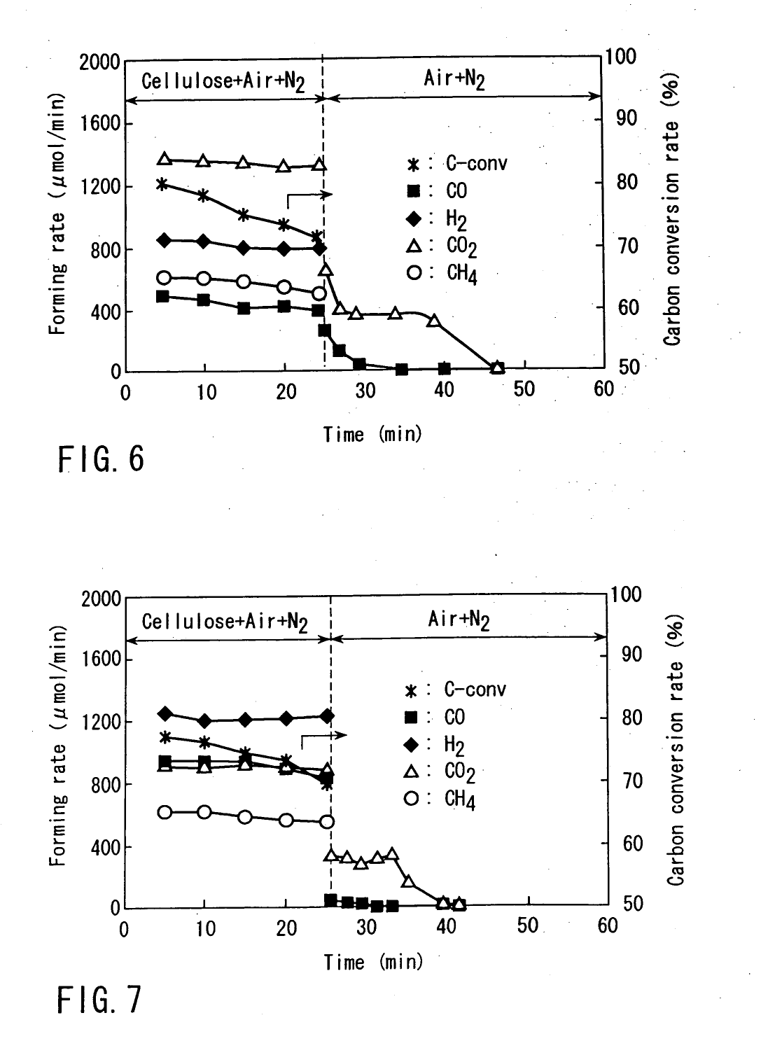

Incidentally, FIG. 2 covers the case of using Rh/CeO₂/SiO₂(35) as the catalyst, FIG. 3 covers the case of using the Rh/SiO₂ catalyst, FIG. 4 covers the case of using the G-91 catalyst, FIG. 5 covers the case of using the Rh/CeO₂ catalyst, FIG. 6 covers the case of using Rh/CeO₂/Al₂O₃(30) as the catalyst, and FIG. 7 covers the case of using Rh/CeO₂/ZrO₂(50) as the catalyst.

As shown in FIG. 2, the carbon conversion rate (C-conv) and the forming rate were very stable over the reaction time of 25 minutes in the case of using Rh/CeO₂/SiO₂(35) as the catalyst, though the reaction was carried out under a very low temperature. If the supply of cellulose is stopped 25 minutes later, CO₂ is mainly generated by the combustion of the char on the catalyst. The forming rate of CO₂ is decreased with time, and the rate of decrease on the catalyst of Rh/CeO₂/SiO₂(35) is markedly higher than that on the other catalysts. This clearly supports a high combustion activity of the Rh/CeO₂/SiO₂(35) catalyst.

On the other hand, the carbon conversion rate (C-conv) on the Rh/SiO₂ catalyst is rapidly decreased over several minutes as shown in FIG. 3. It is considered reasonable to understand that the deposited char deactivates the Rh/SiO₂ catalyst so as to cause the formation of CO and H₂ to be decreased with time. Since the methane-forming reaction proceeds on a clean surface of metal, the rapid decrease in the methane forming rate supports that the surface of the catalyst was covered with tar and char.

FIG. 4 shows that the carbon conversion rate (C-conv) and the formation of the gases other than CO₂ are gradually lowered in the case of using the G-91 catalyst. Each of the Rh/SiO₂ catalyst and the G-91 catalyst is very low in the char combustion activity. As a matter of fact, the CO₂ formation derived from the combustion of the char on the surfaces of the Rh/SiO₂ catalyst and the G-91 catalyst continued for a time longer than that in the case of using the Rh/CeO₂/SiO₂ catalyst. It is possible to estimate the amount of char from this experiment.

As shown in FIG. 5, the carbon conversion (C-conv) on the Rh/CeO₂ catalyst is relatively low. The increase in the CO₂ forming rate is related to the increase with time in the amount of char.

As shown in FIGS. 6 and 7, the carbon conversion (C-conv) on each of the Rh/CeO₂/Al₂O₃ catalyst and the Rh/CeO₂/ZrO₂ catalyst is decreased with time. The char combustion rate on each of the Rh/CeO₂/Al₂O₃ catalyst and the Rh/CeO₂/ZrO₂ catalyst is very low compared with that in the case of using the Rh/CeO₂/SiO₂(35) catalyst.

The experimental data described above support that the Rh/CeO₂/SiO₂(35) catalyst exhibits the highest performance in terms of the forming rate and the high combustion activity. The carbon conversion rate (C-conv) is considered to be one of the most important factors that must be taken into account in selecting the catalyst. In this sense, the Rh/CeO₂/SiO₂(35) catalyst exhibited the highest performance, i.e., C-conv. of 85%, even at a low temperature (773K). Further, the Rh/CeO₂/SiO₂(35) catalyst was effective for forming considerably large amounts of hydrogen and CO, and the BET surface area was maintained substantially constant even after the reaction carried out for several hours. The prominent effect is produced partly because the mutual function performed between CeO₂ and SiO₂ inhibits the sintering of CeO₂ and partly because Rh is dispersed on the surface of the CeO₂ particles so as to produce an effective function.

If the SiO₂ particles included in the Rh/CeO₂/SiO₂ catalyst have a small specific surface area such as 200 m²/g or 50 m²/g, the catalytic function of the catalyst is lowered in the gasification of cellulose. This is derived from a low dispersion capability of Rh on a relatively small surface of CeO₂/SiO₂. Since the gasification temperature in this Example, which is 773K, is lower than the ordinary gasification temperature of 1,173K, the levels of the carbon conversion rate (C-conv), which was 23%, and the amount of the hydrogen formation, which was 24 μmol, are further lowered in the non-catalytic system. The main formed products in this case are char and tar. In the case of using the other catalysts such as G-91, Rh/CeO₂, Rh/SiO₂, Rh/ZrO₂ and Rh/Al₂O₃, the carbon conversion rate (C-conv) is certainly improved, compared with the case where the catalyst is not added. However, the level of the carbon conversion (C-conv) is lower than that in the case of using the Rh/CeO₂/SiO₂(35) catalyst. Further, the formed amounts of char and tar in this case are smaller than those in the case of using the Rh/CeO₂/SiO₂(35) catalyst.

Table 1 shows the BET specific surface areas of the catalysts before and after use. The BET specific surface area of Rh/CeO₂ catalyst is markedly decreased by the reaction. Also, the BET specific surface area was slightly decreased in the case of using the Rh/CeO₂/Al₂O₃ catalyst. Further, SiO₂ and ZrO₂ were found to be highly effective for decreasing the BET specific surface area after the reaction.

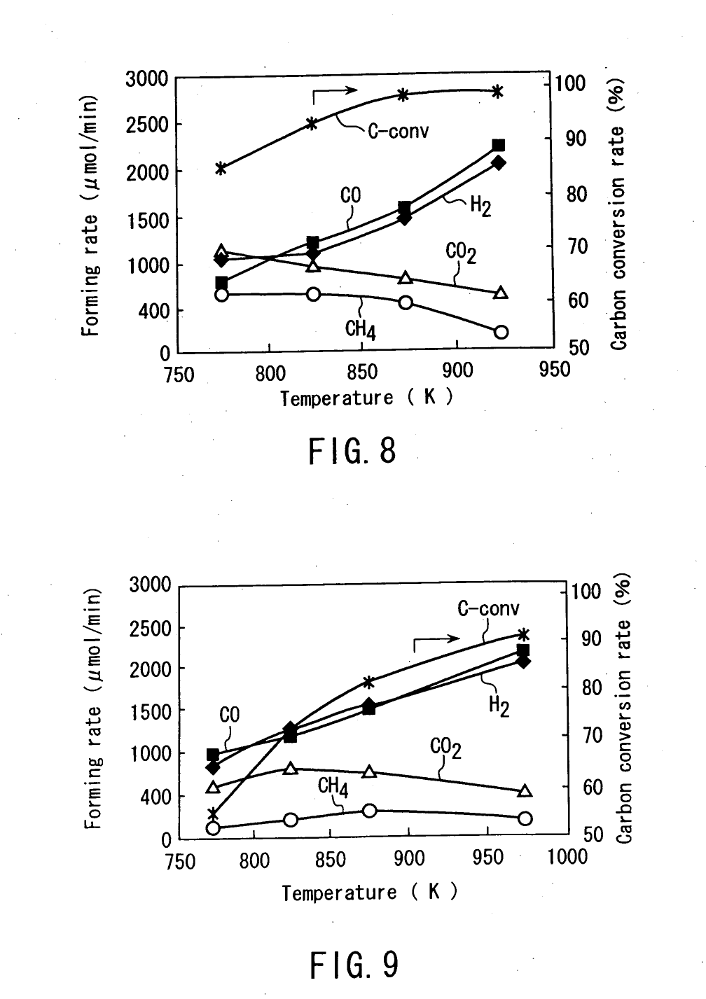

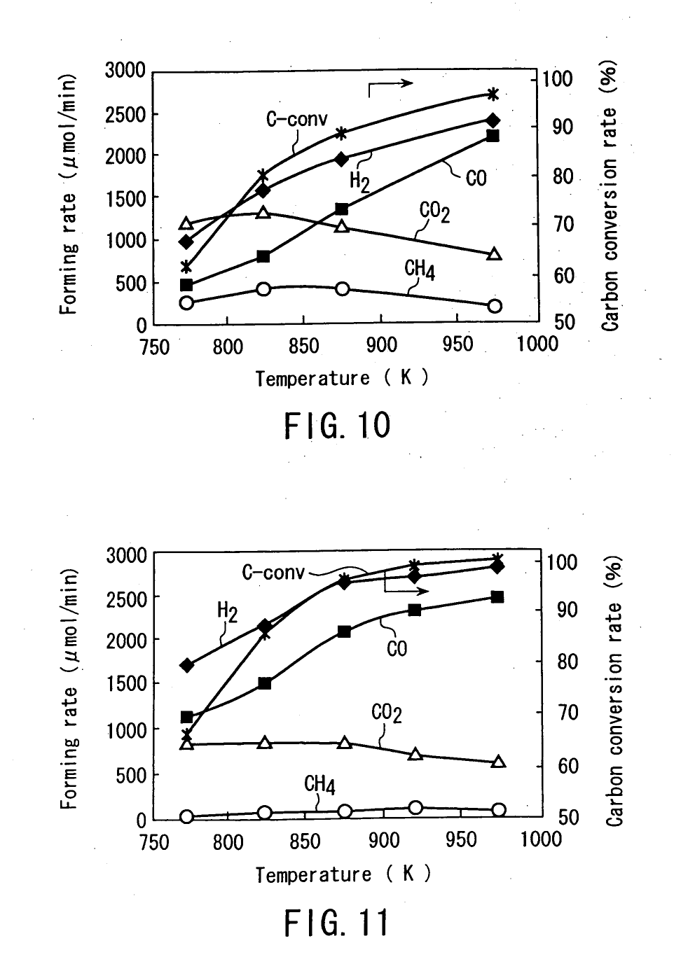

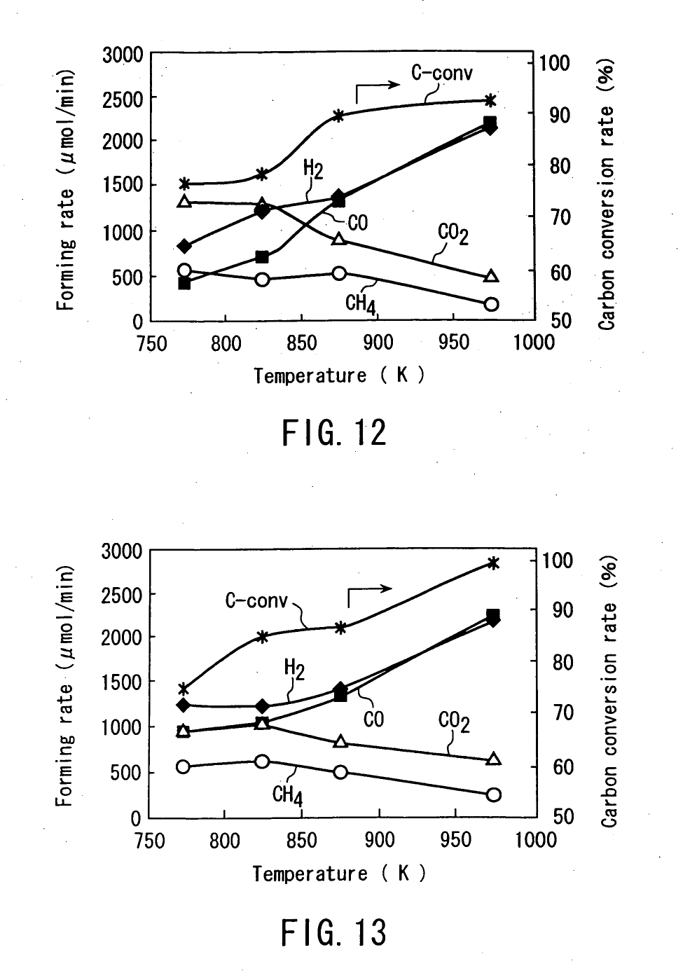

FIGS. 8 to 13 are graphs each showing the changes with temperature in the forming rate in the cellulose gasification in a catalytic system and in the carbon conversion rate (C-conv) in the cellulose gasification. FIG. 8 covers the case where Rh/CeO₂/SiO₂(35) was used as the catalyst, FIG. 9 covers the case where Rh/SiO₂ was used as the catalyst, FIG. 10 covers the case where G-91 was used as the catalyst, FIG. 11 covers the case where Rh/CeO₂ was used as the catalyst, FIG. 12 covers the case where Rh/CeO₂/Al₂O₃ was used as the catalyst, and FIG. 13 covers the case where Rh/CeO₂/ZrO₂ was used as the catalyst.

The gasification of cellulose was carried out under the conditions given below:
Catalyst amount: 3 g;
Cellulose supply rate: 85 mg/min (C: 3148 μmol/min, H: 5245 μmol/min, O: 2622 μmol/min);
Air flow rate: 51 cm³/min (O₂: 417 μmol/min);
N₂ flow rate: 51 cm³/min.

As shown in FIG. 9, the carbon conversion rate (C-conv) in the presence of the Rh/SiO₂ catalyst was 55% at 773K and 91% at 973K. These values are slightly increased in the case of using the G-91 catalyst as shown in FIG. 10, i.e., 62% at 773K and 93% at 973K. In the case of using the Rh/CeO₂ catalyst, the Rh/CeO₂/Al₂O₃ catalyst and the Rh/CeO₂/ZrO₂ catalyst, the carbon conversion rate (C-conv) was found to be higher than that in the case of using the Rh/SiO₂ catalyst or the G-91 catalyst, as shown in FIGS. 11, 12 and 13. This supports that CeO₂ is highly effective for improving the carbon conversion rate (C-conv). The carbon conversion rate, which was 67% at 773K, was found to reach about 100% at 923K in the case of using the Rh/CeO₂/SiO₂ catalyst.

If the temperature is elevated, the yields of Co and H₂ are increased. However, the forming rates of CO₂ and CH₄ are lowered with increase in the reaction temperature. This tendency can be anticipated by the thermodynamics in the manufacture of a syngas. Table 3 given below shows the temperatures at which the carbon conversion rate (C-conv) reaches 90% in the presence of various catalysts. These temperatures can be anticipated from the temperature dependency of various catalysts shown in FIGS. 8 to 13 referred to previously. As shown in Table 3, the Rh/CeO₂/SiO₂(35) catalyst permits lowering the temperature at which the carbon conversion rate (C-conv) reaches 90%, compared with the other catalysts.

TABLE 3

| Catalyst | Temp. (K) |
|---|---|
| Rh/CeO₂/SiO₂ (35) | 795 |
| Rh/SiO₂ | 960 |
| G-91 | 905 |
| Rh/CeO₂ | 845 |
| Rh/CeO₂/Al₂O₃ (30) | 875 |
| Rh/CeO₂/ZrO₂ (50) | 900 |

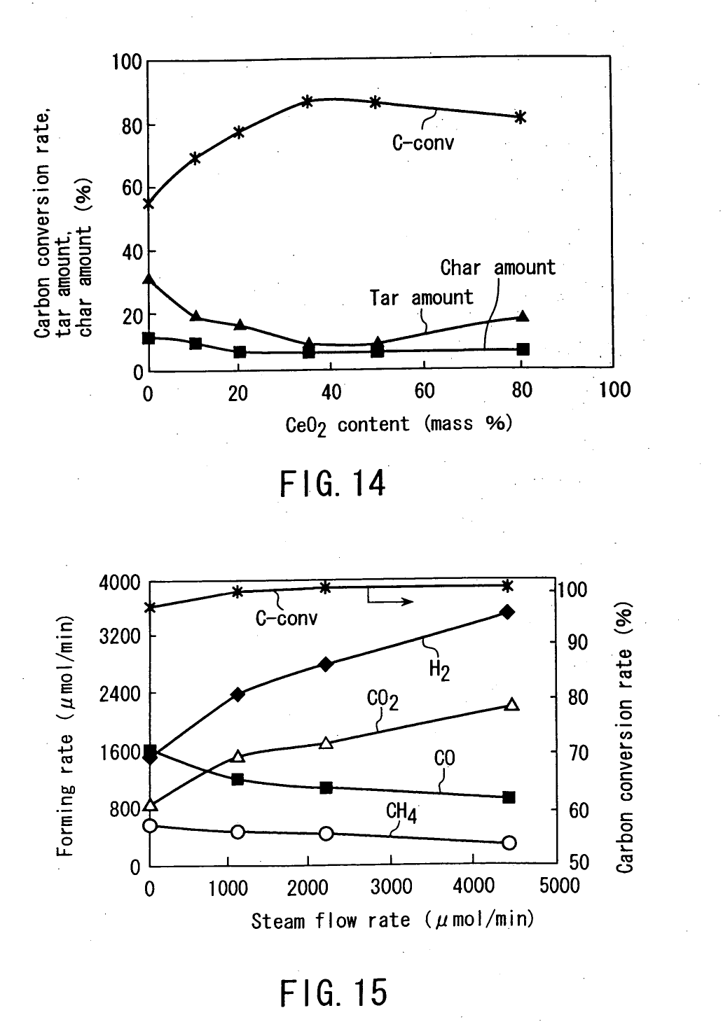

FIG. 14 is a graph showing the performance of the Rh/CeO₂/SiO₂ catalyst accompanying the change in the CeO₂ content (mass %) on SiO₂ (380 m²/g). The conditions in this case were as follows:
Catalyst amount: 3 g;
Cellulose supply rate: 85 mg/min (C:3148 μmol/min, H: 5245 μmol/min, O: 2622 μmol/min);
Air flow rate: 51 cm³/min (O₂: 417 mmol/min);
N₂ flow rate: 51 cm³/min.

The carbon conversion rate (C-conv) is increased to reach 86% until the CeO₂ content is increased to 35 mass %, and the carbon conversion rate is decreased if the amount of CeO₂ on SiO₂ exceeds 35%. On the other hand, the amount of the char formation is gradually decreased with increase in the amount of CeO₂, which suggests that CeO₂ is involved in the conversion to char. The tar formation is decreased until the amount of CeO₂ is decreased to 35 mass % and is increased in the case of using 80 mass % of CeO₂. This suggests that the conversion to tar requires CeO₂ particles having a high specific surface area adapted for a sufficient dispersion of Rh.

As described below, tar is converted by the reforming with steam. In the case of using SiO₂ alone or Rh/SiO₂ as the catalyst, the carbon conversion rate (C-conv) and the formation of hydrogen and CO are very low. Therefore, where the CeO₂ content on SiO₂ is low, e.g., 10 mass % or 20 mass %, it is difficult to overcome the negative factor of SiO₂ in the Rh/CeO₂/SiO₂ catalyst in gasifying cellulose. Further, if the CeO₂ content is further increased, the formation of CeO₂ crystals on SiO₂ is brought about so as to lower the dispersion capability of CeO₂ and Rh, resulting in a lowered performance of the catalyst.

The influences of steam given in the gasifying process of cellulose were examined, with the results as shown in FIG. 15. In this experiment, the reaction temperature was set at 873K and 3 g of the catalyst was used. The other conditions of this experiment were as follows:
Cellulose supply rate: 85 mg/min (C: 3148 μmol/min, H: 5245 μmol/min, O: 2622 μmol/min);
Air flow rate: 51 cm³/min (O₂: 417 μmol/min);
N₂ flow rate: 51 cm³/min.

Where steam was not introduced, 97% of the carbon conversion rate (C-conv) was achieved, and 100% of C-conv. was confirmed in the case of introducing at least 1,111 μmol/min of steam. The steam introduction into the reaction system greatly changes the distribution of the formed products. Since the water-gas shift reaction (CO+H₂O→CO₂+H₂) proceeds in the presence of steam, the forming rates of H₂ and CO₂ are increased at a prescribed rate in accordance with increase in the flow rate of steam. On the other hand, the forming rate of CO is decreased with increase in the flow rate of steam. Further, the forming rate of methane is gradually decreased with increase in the flow rate of steam, which is caused by the steam reforming of methane under the similar conditions. These results indicate that the composition of the formed gases are adjusted at the desired composition.

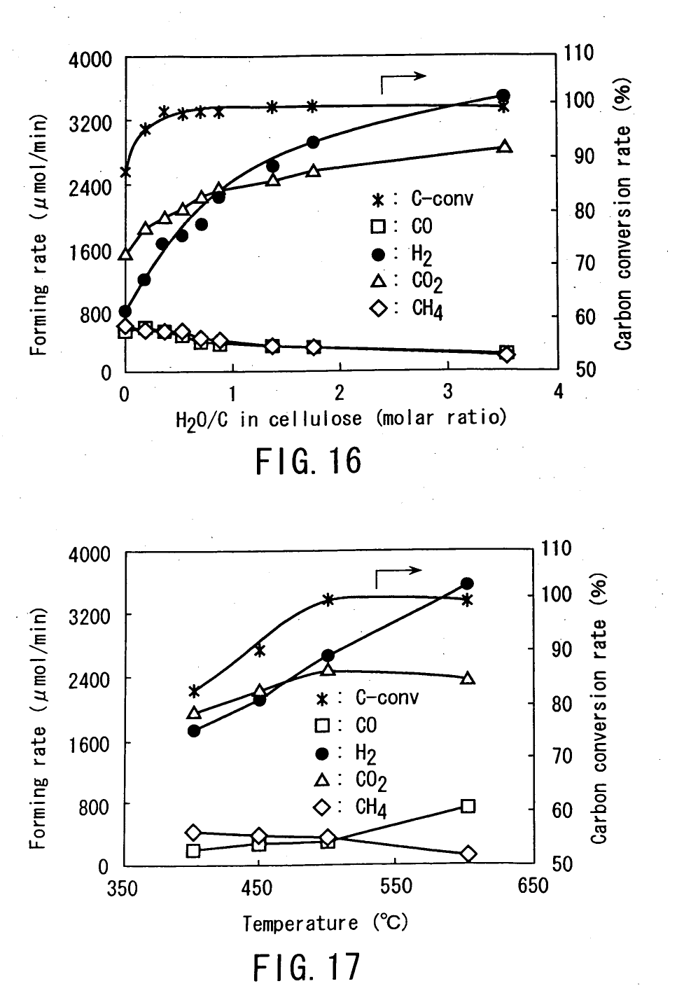

FIG. 16 is a graph showing the effects given by the supplied steam to the carbon conversion rate (C-conv) and the forming rate in the gasification of cellulose using the Rh/CeO₂/SiO₂(35) catalyst. The reaction temperature was set at 773K and the other conditions were as follows:
Cellulose supply rate: 85 mg/min (C: 3148 mmol/min, H: 5246 μmol/min, O: 2624 μmol/min);
Air flow rate: 100 cm³/min (O₂: 818 μmol/min);
N₂ flow rate: 50 cm³/min (N₂: 2046 μmol/min);
H₂O flow rate: 555 to 11,110 μmol/min.

As shown in FIG. 16, the carbon conversion rate (C-conv) and the selectivity of the formed gas were drastically improved by the introduction of steam. Where steam was not introduced, the carbon conversion rate (C-conv) was 88%, and the amount of hydrogen formed was small. On the other hand, the C-conv. was increased to reach 100%, and the amount of the hydrogen formation was also increased by simply introducing steam of H₂O/C=0.35. Further, the formation of hydrogen and CO₂ was increased with increase of H₂O/C. In this fashion, it has been confirmed that the C-conv. and the amount of the hydrogen formation are markedly increased by the steam addition.

FIG. 17 is a graph showing the influences of temperature in the case of introducing steam. The graph of FIG. 17 shows the forming rate and the carbon conversion rate (C-conv) under much lower temperatures in the gasification of cellulose using the Rh/CeO₂/SiO₂(35) catalyst. The conditions for the reaction in this case were as follows:
Cellulose supply rate: 85 mg/min (C: 3148 mmol/min, H: 5246 μmol/min, O: 2624 μmol/min);
Air flow rate: 100 cm³/min (O₂: 818 μmol/min);
N₂ flow rate: 50 cm³/min;
H₂O flow rate: 4,444 μmol/min.

At the temperature of 878K, a half amount of hydrogen was present in cellulose, and the steam was converted into H₂. The temperature noted above is lower than the ordinary gasifying temperature (1,173K). At this temperature, the amount of methane formation was markedly decreased. However, the amount of CO formation was slightly increased.

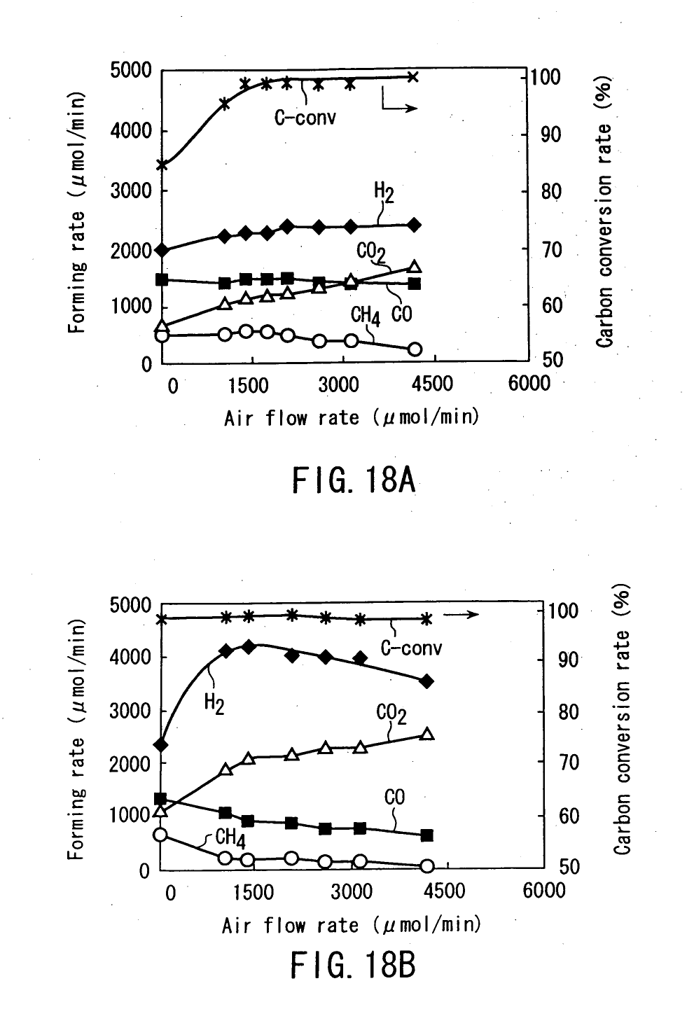

The composition of the formed gas is also dependent on the air flow rate. The influences of the air flow rate on the reaction system were examined, with the results as shown in FIGS. 18A and 18B. The reaction temperature was set at 873K and 3 g of the catalyst was used in this experiment. The other conditions were as follows:
Cellulose supply rate: 85 mg/min (C: 3148 μmol/min, H: 5245 μmol/min, O: 2622 μmol/min)

FIG. 18A covers the case where the steam flow rate was set at 833 μmol/min, and FIG. 18B covers the case where the steam flow rate was set at 5,555 μmol/min.

The carbon conversion rate (C-conv) is a function of the air and steam. As shown in FIG. 18A, where the amount of steam is small (833 μmol/min) and air is not present, the carbon conversion rate (C-conv) is relatively low, i.e., 86%. In contraries, the C-conv. can be markedly increased by introducing air. This is because the reactivity of char to air is markedly higher than the reactivity of char to steam. The CO₂ forming rate is markedly increased by introducing air. On the other hand, the methane formation is slightly decreased with increase in the air flow rate. Since methane is formed by the hydrogenation of CO (i.e., the reaction of CO+3H₂→CH₄+H₂O), the decrease in the CO forming rate is related to the hydrogenation of CO to form methane.

In the presence of a large amount of steam, the carbon conversion rate (C-conv) is high even if air is not introduced into the reaction system, as shown in FIG. 18B. This indicates that char can be gasified under a high steam partial pressure. The introduction of a small amount of air and a large amount of steam greatly changes the distribution of the formed products. The formation of hydrogen is rapidly increased to reach the maximum value when air is introduced at a rate of 1,043 μmol/min, and is gradually decreased with further increase in the air flow rate. Since it is desirable for the forming rate of hydrogen to be not lower than 3,500 μmol/min, it is desirable for the air flow rate to fall within a range of 1,000 μmol/min to 4,000 μmol/min. Where an excessively large amount of oxygen is present in the reaction system, tar is desirably involved in the combustion reaction so as to decrease the formation of hydrogen and CO with increase in the air flow rate. Similarly, CO₂ is increased and the methane formation is decreased with increase in the air flow rate. In such a catalytic gasification of cellulose, hydrogen, CO and methane are considered to be useful formed products. This is because the syngas (H₂+CO) can be converted into a clean liquid fuel, and methane can be used as a gaseous fuel. Such being the situation, the yields were compared under various reacting conditions.

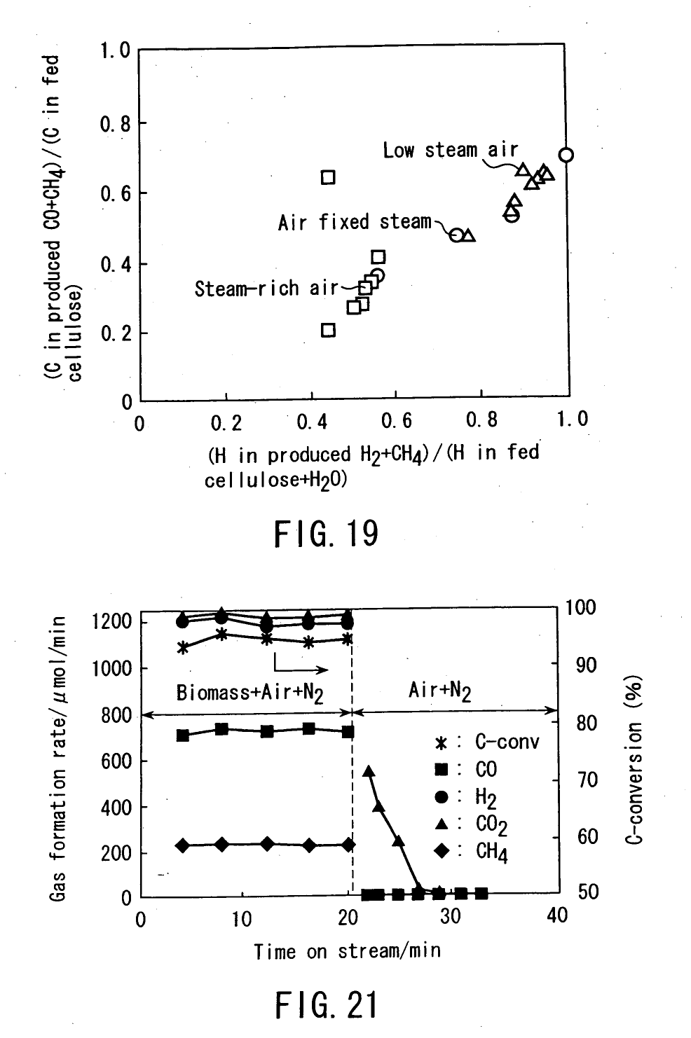

FIG. 19 is a graph showing the relationship between the yield of H₂+CH₄ and the yield of CO+CH₄ from cellulose, steam and air in the presence of the Rh/CeO₂/SiO₂(35) catalyst. Under a certain reacting condition, the yield of hydrogen in H₂+CH₄ is close to 1, which indicates that the effective conversion into hydrogen is carried out even at low temperatures. At the same time, the converting efficiency into carbon is also high.

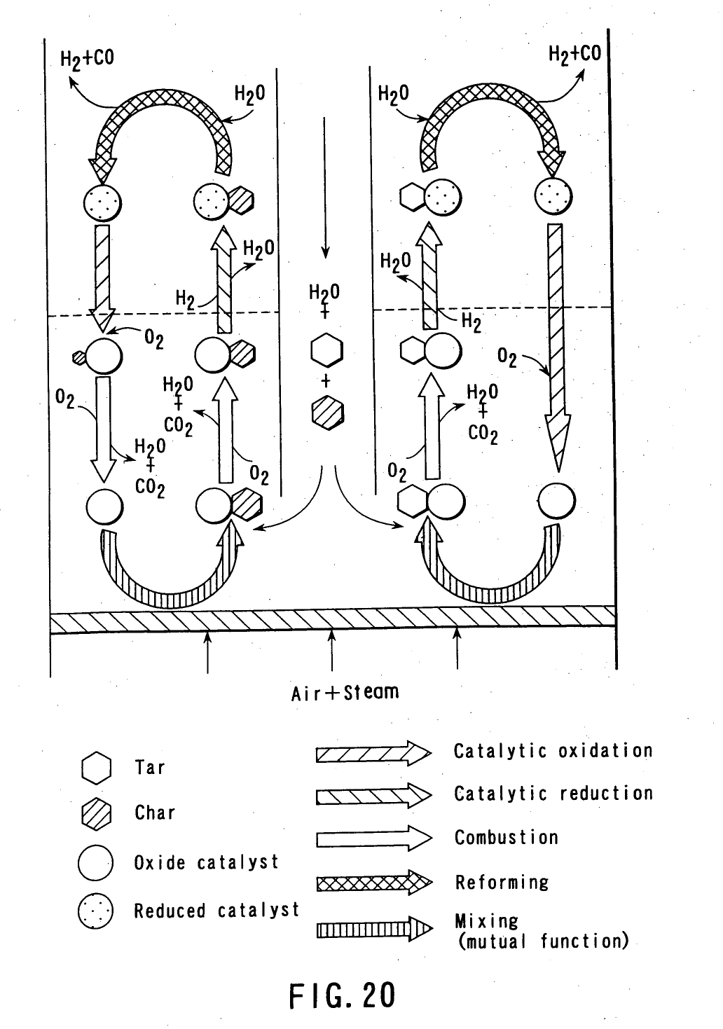

In the gasifying process of the present invention, the catalyst of Rh/CeO₂/SiO₂(35) is considered to perform multi-functions as shown in FIG. 1. The fluidized catalyst bed is divided into three regions comprising the thermal decomposition region, the combustion region and the reforming region. FIG. 20 schematically shows the model of the reaction carried out in such a fluidized bed reactor.

In the first step, cellulose particles are supplied into the thermal decomposition region in which any of oxygen and steam is not present. The thermal decomposition of cellulose into tar, char, steam and a small amount of gases proceeds in the thermal decomposition region. Since the thermal decomposition proceeds under very low temperatures, very small amounts of gases such as CO, H₂, CO₂ and CₙHₘ are formed in the thermal decomposition region. All the products formed in the thermal decomposition region are introduced by the N₂ carrier gas into the combustion region of the catalyst bed.

In a lower portion of the fluidized bed in which oxygen is present, the catalyst is in the oxidized state, and the tar and char are partly combusted so as to form CO₂ and H₂O. Then, the catalyst particles are fluidized upward so as to be reduced by hydrogen and CO.

Then, the reduced catalyst contributes to the steam reforming of the tar and char so as to form CO and hydrogen. Many secondary reactions also take place in the reforming region. Carbon dioxide (CO₂) is formed by the water-gas shift reaction, i.e., the reaction of CO+H₂O→CO₂+H₂, and hydrogen is formed under a particularly high steam pressure. Methane is also formed by the methane forming reaction of CO+3H₂→CH₄+H₂O.

Steam is directly takes part in the carbon conversion rate (C-conv) into a gas so as to markedly improve particularly the char conversion rate. As a result, 100% of the carbon conversion rate (C-conv) can be achieved even at a low temperature of 773K so as to achieve a high yield of hydrogen. This is derived from a high steam reforming activity of the char and tar on the reduced catalyst of Rh/CeO₂/SiO₂(35) in an upper portion of the reactor. On the catalyst of Rh/CeO₂/SiO₂(35) having a high activity, the tar is considered to be converted completely. However, it is possible for the char to remain partly on the surface of the catalyst in the reforming region. Since the catalyst bed is present in a fluidized state, the catalyst and oxygen further perform a mutual function in a lower portion of the reactor, with the result that the catalyst further contributes to the combustion of the char remaining on the surface of the catalyst.

The fluidized bed reactor is highly effective for removing the carbonaceous component low in reactivity in the methane reforming using CO₂ and O₂. The high performance of the Rh/CeO₂/SiO₂ catalyst is considered to be derived from the smooth oxidation-reduction characteristics achieved by the combination of Rh and CeO₂. The Rh/CeO₂/SiO₂ catalyst also exhibits a high performance in view of the stability, too. Silicon dioxide (SiO₂) inhibits the sintering of CeO₂ so as to permit the Rh metal particles to be dispersed uniformly on the CeO₂ particles. Further, the fluidized bed reactor promotes the heat dissipation from the exothermic region into the endothermic region so as to make the temperature uniform within the reactor.

In the system of the present invention, the lower region of the reactor constitutes an exothermic region, and the upper region of the reactor constitutes an endothermic region. On the other hand, the difference in temperature between the lower region and the upper region of the reactor and between the outside and the inside of the reactor is only 15K. By the combination of the Rh/CeO₂/SiO₂ catalyst having a high reactivity and the fluidized bed reactor, it is possible to obtain a novel system for manufacturing hydrogen and a syngas from a biomass under low temperatures and with a high energy efficiency.

The Example described above is directed to the gasification of a biomass with cellulose used as an example of the biomass. However, the present invention is not limited to the particular example.

Specifically, gasification of a cedar powder used as an example of the biomass was performed by using a continuous supply fluidized bed reactor at temperatures ranging between 823K and 973K. The cedar powder used contained 45.99% by weight of C, 10% by weight of H₂O, 5.31% by weight of H, 38.25% by weight of O, 0.11% by weight of N, 0.1% by weight of Cl, and 0.2% by weight of S.

The apparatus used in this experiment was substantially equal to that shown in FIG. 1.

The gasifying reactor was formed of a quartz tube having a height of 66 cm. A fluidized bed portion having a height of 5 cm and an inner diameter of 18 mm was formed in the central portion of the reactor. The inner diameter in the upper portion of the reactor immediately downstream of the fluidized bed portion was large, i.e., 30 mm, and, thus, the speed of flow of the gas is rapidly lowered in the particular portion so as to permit the catalyst particles to return easily into the fluidized bed portion.

The biomass feeder was formed of a glass reactor having a small opening with a diameter of about 0.5 mm formed in the bottom portion, and the biomass was consecutively supplied into the glass reactor while vibrating the glass reactor with an electric vibrator. The supply rate of the biomass was controlled by controlling the vibrating speed. The biomass particles were carried through an inner tube having an inner diameter of 8.5 mm into the catalyst bed by utilizing a N₂ gas stream. The air was also introduced as a gasifying agent into the catalyst bed through a bottom portion of the reactor. The air thus introduced into the catalyst bed also serves to fluidize the catalyst particles.

The catalyst bed temperature was measured at various points with thermocouples. A sample of the formed gas was collected from a sampling port with a microsyringe and analyzed by a gas chromatograph (GC) so as to obtain CO, CO₂, CH₄, H₂ and H₂O as formed products. The concentrations of CO, CO₂ and CH₄ were determined by the FID-GC referred to previously, and the concentration of hydrogen was determined by the TCD-GC referred to previously.

The carbon conversion rate (C-conv) was calculated by the formula “(forming rate of CO+CO₂+CH₄)/(carbon supply rate in biomass)”. The obtained value of C-conv. was the average value over 20 minutes. The amount of char was determined by the amount of the gas, mainly CO₂, generated under the air stream at the reaction temperature after the biomass ceased to be supplied. The amount of char was calculated by the formula “(CO₂+CO total amount)/(all the carbon amount in supplied biomass) and tar was defined as (100−(C-conv)(%)−char amount (%)).

The catalysts, which were used, will now be described.

The CeO₂/SiO₂ catalyst was prepared by the incipient wetness method using an aqueous solution of Ce(NH₄)₂(NO₃)₆ and SiO₂ (Aerosil 380 m²/g). Ceria (CeO₂) was supported in an amount of 60% by weight, which is indicated within the parenthesis. The support was subjected to a heat treatment at 393K for 12 hours, followed by further subjecting the support to heat treatments within the air at 773K for 2 hours and, then, at 873K for one hour. Rhodium (Rh) was supported by CeO₂/SiO₂ by impregnating the support with an acetone solution of Rh(C₅H₇O₂)₃. After evaporation of the acetone solvent, the catalyst was dried at 393K for 12 hours. The final catalyst was compressed, pulverized and, then, sieved to have a particle diameter falling within a range of between 44 μm and 149 μm. The supported amount of Rh was 1.2×10⁻⁴ mol/g of the catalyst. In each experiment, the catalyst was treated with a hydrogen stream at 773K for 0.5 hour by using 3 g of the catalyst. The BET specific surface areas before use (immediately after treatment with H₂) and after use were measured by the BET method.

For comparison, prepared were steam reforming catalysts available on the marked (TOYO, CCI, G-91) and dolomite. The steam reforming catalysts (TOYO, CCI, G-91) contained 14% by weight of Ni, 65 to 70% by weight of Al₂O₃, 10 to 14% by weight of CaO, and 1.4 to 1.8% by weight of K₂O. On the other hand, dolomite contained 21.0% by weight of MgO, 30.0% by weight of CaO, 0.7% by weight of SiO₂, 0.1% by weight of Fe₂O₃, and 0.5% by weight of Al₂O₃. Before the reaction, dolomite was subjected to a heat treatment at 773K for 3 hours, followed by treating the dolomite with hydrogen for 0.5 hour.

In the first step, a cedar powder used as a biomass was gasified at 873K by using 3 g of the Rh/CeO₂/SiO₂(60) catalyst. FIG. 21 is a graph showing the changes with time in the forming rate of the formed gas and the carbon conversion rate (C-conv) in respect of the Rh/CeO₂/SiO₂(60) catalyst.

The reacting conditions were as follows:
Biomass supply rate: 60 mg/min (H₂O: 10%, C: 2299 μmol/min, H: 3852 μmol/min, total O: 1767 μmol/min);
Air flow rate: 100 cm³/min (N₂: 3274 μmol/min, O₂: 818 μmol/min) (supplied from the bottom portion);
N₂ flow rate: 50 cm³/min (supplied from the top portion).

Since the deactivation of the catalyst is a serious problem in the catalytic gasification of the biomass, the stability of the catalyst is very important in this system. As shown in FIG. 21, during the reaction for 20 minutes, the carbon conversion rate (C-conv) was 95%, which was very stable, even at a low temperature of 873K. The ratio of the formed hydrogen to the formed CO, i.e., (H₂/CO), was 1.7, which was also stable. If the biomass ceased to be supplied, CO₂ and a small amount of CO were formed. The carbon dioxide (CO₂) and CO are considered to be formed by the combustion of the carbonaceous material deposited on the catalyst during the reaction. The amount of the total CO₂+CO corresponds to the char amount.

A gasifying test of the biomass was conducted by using 3 g of the Rh/CeO₂/SiO₂(60) catalyst equal to that referred to above under temperatures ranging between 823K and 973K. The reacting conditions were as follows:
Biomass supply rate: 60 mg/min (H₂O: 10%, C: 2299 μmol/min, H: 3852 μmol/min, total O: 1767 μmol/min);
Air flow rate: 100 cm³/min (N₂: 3274 μmol/min, O₂: 818 μmol/min) (supplied from the bottom portion);
N₂ flow rate: 50 cm³/min (supplied from the top portion).

The gasification of a biomass was conducted under conditions equal to those given above by using a steam reforming catalyst (G-91) and dolomite. The gasification of a biomass was also conducted under conditions equal to those given above without using a catalyst. Incidentally, the reaction temperature was set at 1,173K in the case of using dolomite and in the non-catalyst case.

Table 4 shows the forming rate of the formed gas, the carbon conversion rate (C-conv), the char amount, the tar amount and the BET specific surface area, which were obtained in each gasification test.

TABLE 4

| | | | | | | | | | Surface | |
|---|---|---|---|---|---|---|---|---|---|---|
| | | Formation rate/μmol/min | | | | C-conv | Char | Tar | area (m²/g) | |
| Catalyst | T/K | CO | H₂ | CO₂ | CH₄ | (%) | (%) | (%) | Fresh | Used |
| Rh/CeO₂/SiO₂ (60) | 823 | 536 | 883 | 1155 | 255 | 85 | 10 | 5 | 123 | 118 |
| | 873 | 676 | 1116 | 1240 | 254 | 95 | 5 | 0 | | |
| | 923 | 890 | 1117 | 1095 | 272 | 98 | 2 | 0 | | |
| | 973 | 945 | 1207 | 1097 | 238 | 99 | 1 | 0 | | |
| G-91 | 823 | 487 | 795 | 1081 | 57 | 71 | 20 | 9 | 33 | 31 |
| | 873 | 494 | 1131 | 1130 | 95 | 75 | 19 | 6 | | |
| | 923 | 695 | 1300 | 1188 | 85 | 85 | 10 | 5 | | |
| | 973 | 975 | 1385 | 1025 | 57 | 90 | 5 | 4 | | |
| Dolomite | 823 | 353 | 156 | 1011 | 40 | 61 | 23 | 16 | 1.1 | 0.9 |
| | 873 | 380 | 298 | 1008 | 67 | 63 | 20 | 17 | | |
| | 923 | 490 | 353 | 1036 | 133 | 72 | 16 | 12 | | |
| | 973 | 618 | 412 | 912 | 176 | 74 | 15 | 11 | | |
| | 1073 | 569 | 615 | 979 | 209 | 77 | 12 | 11 | | |
| | 1173 | 655 | 720 | 935 | 245 | 80 | 8 | 12 | | |
| Non-catalyst | 823 | 285 | 66 | 420 | 38 | 32 | 12 | 54 | — | — |
| | 873 | 365 | 105 | 545 | 99 | 44 | 6 | 48 | | |
| | 923 | 470 | 111 | 660 | 108 | 54 | 6 | 40 | | |
| | 973 | 705 | 141 | 559 | 123 | 60 | 5 | 35 | | |
| | 1073 | 710 | 250 | 598 | 201 | 65 | 4 | 31 | | |
| | 1173 | 818 | 378 | 757 | 217 | 78 | 2 | 20 | | |

As shown in Table 4, the amount of char deposited on the Rh/CeO₂/SiO₂(60) catalyst was markedly smaller than that deposited on the other catalysts. This is related to the oxidizing activity of the catalyst. The present inventors have confirmed that the combustion activity of methane on the catalyst is markedly high. Under such reacting conditions, the forming rate of CO₂ is higher than the forming rate of CO. This can be accounted for by the situation that the inert tar and char on the surface of the catalyst are converted and combusted so as to form CO₂ so as to realize a high carbon conversion rate (C-conv). Further, various secondary reactions such as the hydrogenation of CO to form methane and the water-gas shift reaction take place on the Rh/CeO₂/SiO₂(60) catalyst. All of these reactions contribute to the decrease of CO and the increase of CO₂. FIG. 21 is a graph showing that methane is formed in this system and that the forming rate is highly stable.

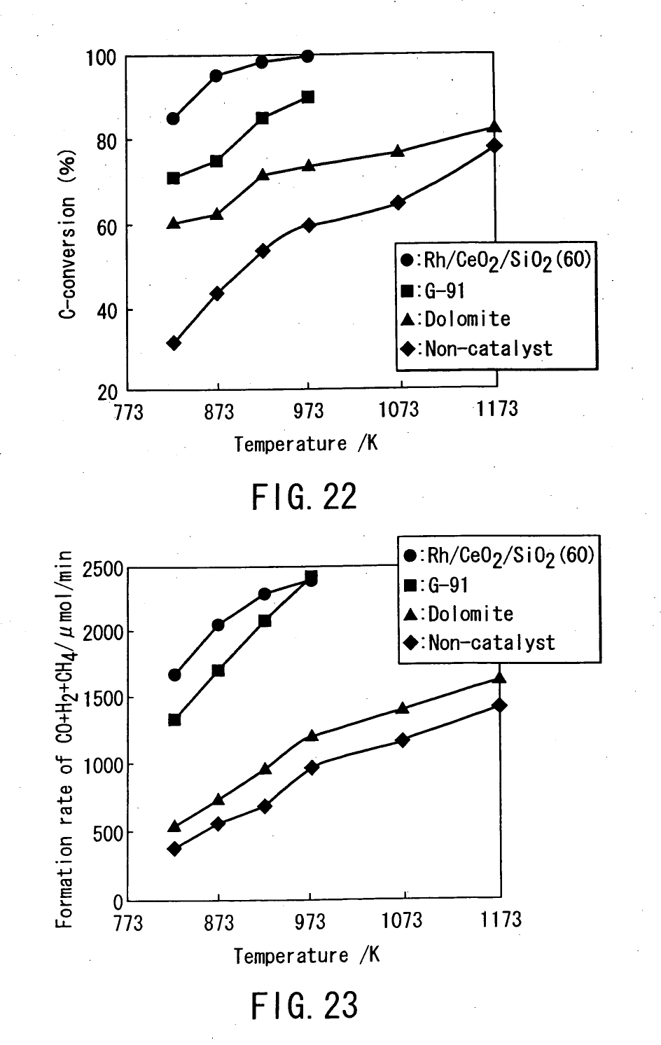

FIG. 22 is a graph showing the carbon conversion rates (C-conv) in various reaction systems. It is seen that the C-conv. is in the order of Rh/CeO₂/SiO₂(60)>G-91>dolomite>non-catalyst under temperatures ranging between 823K and 973K. Specifically, the carbon conversion rate (C-conv) on the Rh/CeO₂/SiO₂(60) catalyst is high, which exceeds 95%, under temperatures ranging between 873K and 973K. The carbon conversion rate (C-conv) on the G-91 catalyst fails to reach 95% even under 973K. Further, C-conv. on dolomite and in the case of non-catalyst fails to reach 95% even under 1,173K. It can be understood from the comparison of the char amounts shown in Table 4 given previously that the high C-conv. is derived from a small char amount, which indicates that the Rh/CeO₂/SiO₂(60) catalyst exhibits a very high performance for the removal of char. Further, the amount of tar formation on the Rh/CeO₂/SiO₂(60) catalyst is smaller than that on the other catalysts. This also indicates that the Rh/CeO₂/SiO₂(60) catalyst exhibits a very high activity for the conversion of tar into a gas.

FIG. 23 is a graph showing the changes with temperature in the forming rate of CO+H₂+CH₄ in the presence of each of the catalytic systems. Where the formed gas is used for the fuel synthesis (Fischer-Tropsch, methanol and dimethyl ether), CO and H₂ are useful formed products. Where the formed products are used for the power generation, CO, H₂ and CH₄ are useful formed products. Therefore, the total forming rate of CO+H₂+CH₄ is important. The change with temperature in the total forming rate is close to the change with temperature in C-conv. shown in the graph of FIG. 22.

The useful formed products are formed on the Rh/CeO₂/SiO₂(60) catalyst under temperatures much lower than those formed on the other catalysts. In the case of dolomite and non-catalyst, the total forming rate under 1,173K is much lower than the total forming rate on the Rh/CeO₂/SiO₂(60) catalyst under 823K. This supports that the Rh/CeO₂/SiO₂(60) catalyst provides a highly useful system in energy in the gasification of the biomass. The difference in the total forming rate between the use of the Rh/CeO₂/SiO₂(60) catalyst and the G-91 catalyst seems to be smaller than the difference in the carbon conversion rate (C-conv). As shown in Table 4 given above, a considerably large amount of CH₄ is formed in the presence of the Rh/CeO₂/SiO₂(60) catalyst and CH₄ is not formed in the presence of the conventional G-91 catalyst. In the methane formation of CO+3H₂CH₄+H₂O, considerably large amounts of CO and H₂ are consumed. As a result, the apparent difference in the total forming rate between the use of the Rh/CeO₂/SiO₂(60) catalyst and the use of the G-91 catalyst is rendered small.

The amount of char in the presence of the G-91 catalyst is markedly larger than that in the presence of the Rh/CeO₂/SiO₂(60) catalyst. The deposition of the char-like carbon brings about the deactivation of the catalyst in the manufacturing process of a syngas. Therefore, the steam reforming catalyst G-91 available on the market is deactivated more easily than the Rh/CeO₂/SiO₂(60) catalyst. It is known in the art that the char or coke-like substance is deposited on the surface of an adsorbent. Since such an adsorption does not take place in the bed in the non-catalytic system, the yields were low in the experiment of this time. It should also be noted that the char or coke-like substance is deposited in the cooling region in the top portion of the reactor and is not combusted completely.

Table 4 given previously shows the BET specific surface areas of each catalyst before and after use. The specific surface area of the Rh/CeO₂/SiO₂(60) catalyst after use was found to be substantially equal to that before use. This implies that the sintering of CeO₂, which is a serious problem accompanying the Rh/CeO₂ catalyst, is inhibited by SiO₂ under the reacting conditions. Further, the similar Rh/CeO₂/SiO₂(60) catalyst was used for the gasification of a cedar powder under various temperatures. Deactivation of the catalyst was not observed. This indicates that the harmful substances present in the biomass such as S and Cl do not affect the catalytic activity.

Finally, the Rh/CeO₂/SiO₂(60) catalyst produces a catalytic function effectively in the fluidized bed continuous supply reactor even at low temperatures of 823K to 923K so as to achieve the carbon conversion rate (C-conv) of about 98%. Since the particular catalyst produces high activity in both the reforming and combustion reactions, the tar is completely gasified so as to generate a very small amount of char. It should be noted that S and Cl contained in the biomass do not adversely affect the catalytic activity and, thus, the deactivation of the catalyst is not observed at all during the reaction. Also, the BET specific surface area of the Rh/CeO₂/SiO₂(60) catalyst can be maintained during the gasification reaction. Further, it was possible to obtain a novel system for manufacturing a syngas by using in combination a fluidized bed reactor and the particular catalyst so as to gasify the biomass at low temperatures and with high energy efficiency.

As described above in detail, the present invention provides a method of synthesizing hydrogen and a syngas by efficiently gasifying a biomass at temperatures lower than 800° C. without the formation of tar and char on the surface of the catalyst. The present invention also provides a catalyst capable of manufacturing hydrogen and a syngas by efficiently gasifying a biomass without accumulation of tar or char on the surface of the catalyst even at temperatures lower than 800° C.

The present invention makes it possible to drastically improve energy efficiency in the manufacture of a syngas from a biomass and, thus, can be suitably utilized in industries relating to energy and in the chemical industries for converting syngas. It follows that the present invention has a high industrial value.

Additional advantages and modifications will readily occur to those skilled in the art. Therefore, the present invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method of gasifying a biomass, comprising:
heating a fluidized bed reactor loaded with a catalyst represented by Rh/CeO₂/M, where M represents SiO₂, Al₂O₃ or ZrO₂, to temperatures lower than 800° C.;
introducing biomass particles into said fluidized bed reactor from an upper portion thereof;
introducing air and steam into said fluidized bed reactor from a lower portion thereof; and
allowing said biomass particles to react at the surface of said Rh/CeO₂/M catalyst so as to manufacture hydrogen and a syngas.

2. The method of gasifying a biomass according to claim 1, wherein said fluidized bed reactor is heated to 500 to 700° C.

3. The method of gasifying a biomass according to claim 1, wherein said M is SiO₂.

4. The method of gasifying a biomass according to claim 1, wherein said biomass is cellulose, and the CeO₂ content of said catalyst is not lower than 35% by weight.

5. The method of gasifying a biomass according to claim 1, wherein the CeO₂ content of said catalyst is not lower than 60% by weight.

6. The method of gasifying a biomass according to claim 1, wherein said SiO₂ has a specific surface area not smaller than 380 m²/g.

7. The method of gasifying a biomass according to claim 1, wherein said reaction is carried out under atmospheric pressure.

8. The method of gasifying a biomass according to claim 1, wherein the flow rate of said air falls within a range of between 1,000 μmol/min and 4,000 μmol/min.

9. The method of gasifying a biomass according to claim 1, wherein the flow rate of said steam is not lower than 1,111 μmol/min.

10. A catalyst for gasification of a biomass, said catalyst being represented by Rh/CeO₂/M, where M represents SiO₂, Al₂O₃ or ZrO₂.

11. The catalyst for gasification of a biomass according to claim 10, wherein said M is SiO₂.

12. The catalyst for gasification of a biomass according to claim 10, wherein the content of said CeO₂ is not lower than 35% by weight.

13. The catalyst for gasification of a biomass according to claim 10, wherein the content of said CeO₂ is not lower than 60% by weight.

14. The catalyst for gasification of a biomass according to claim 10, wherein the specific surface area of said SiO₂ is not smaller than 380 m²/g.

15. The catalyst for gasification of a biomass according to claim 10, wherein the catalyst has a particle diameter falling within a range of 74 μm to 240 μm.
